(19) United States
(12) Patent Application Publication
(10) Pub. No.: US 2024/0344619 A1
(43) Pub. Date: Oct. 17, 2024

(54) Multi-Port Valve for Water Treatment

(71) Applicant: AQ Matic Valve and Controls Company, Inc., New Berlin, WI (US)

(72) Inventors: Shawn M. Healy, Nashotah, WI (US); Jeremy Josetti, New Berlin, WI (US)

(21) Appl. No.: 18/638,165

(22) Filed: Apr. 17, 2024

Related U.S. Application Data
(60) Provisional application No. 63/459,786, filed on Apr. 17, 2023.

(51) Int. Cl. F16K 11/07; C02F 1/42; F16K 31/04

(52) U.S. Cl. CPC F16K 11/0716; C02F 1/42; F16K 31/047; C02F 2201/004; C02F 2201/005

(57) ABSTRACT

A multi-port valve for a water treatment system includes a housing having an inlet port, an outlet port, a drain port, a first resin port, a second resin port resin, and a cavity fluidically coupling each of the ports. A drivetrain subassembly is coupled to the housing and includes a first motor and a leadscrew. An injector subassembly is coupled to the housing and includes a second motor, a brine port, and a brine valve. Further, a piston is disposed on the leadscrew and configured to laterally traverse a length of the leadscrew in response to rotation of the leadscrew.

### CROSS REFERENCE TO RELATED APPLICATIONS

This application claims the benefit of priority under 35 USC § 119 (e) to U.S. Provisional Patent Application No. 63/459,786, filed Apr. 17, 2023, the entire contents of which are hereby expressly incorporated by reference into the present application.

### BACKGROUND OF THE INVENTION

### 1. Field of the Invention

The present invention relates in general to a multi-port valve for water treatment. More particularly, the present invention relates to a multi-port valve having an internal lead screw that rotates in order to translate the piston within the multi-port valve without translating motion of the lead screw.

### 2. Discussion of the Related Art

Water treatment systems for softening, filtering, and/or treating water in residential and commercial applications are well known in the art. Many of these water treatment systems include multi-port valves, a resin tank, and a brine tank. Multi-port valves are known in the field that can adjust positioning of components within the valve to control flow of fluid between a water inlet, a water outlet, a drain, the resin tank, and the brine tank.

However, there is a need for a multi-port valve for a water treatment system that controls movement of a piston through the cavity of the multi-port valve to open and close pathways between ports of the multi-port valve and separately controls when a brine valve is opened and closed. Separate control of these features allows for variability in the order of operations, frequency of operations, and duration of operations of the water treatment system.

Preferably, the multi-port valve design would provide a smaller multi-port-valve and water treatment system that does not need to compensate for lateral movement of the leadscrew.

### SUMMARY AND OBJECTS OF THE INVENTION

The present invention is directed to a multi-port valve for water treatment in commercial and residential applications.

In accordance with an embodiment of the invention, a multi-port valve includes a housing having an inlet port, an outlet port, a drain port, a first resin port, a second resin port resin, and a cavity fluidically coupling each of the ports. A drivetrain subassembly is coupled to the housing and includes a first motor and a leadscrew. An injector subassembly is coupled to the housing and includes a second motor, a brine port, and a brine valve. Further, a piston is disposed on the leadscrew and configured to laterally traverse a length of the leadscrew in response to rotation of the leadscrew.

According to another aspect of the invention, the piston includes an inner portion and an outer portion. The inner portion has a central axis aligned with a central axis of the leadscrew. In addition, the inner portion of the piston may include a threaded portion configured to receive a threaded portion of the leadscrew.

According to yet another aspect of the invention, the piston also includes at least one support extending between the inner and outer portions of the pistons. The one or more supports are spaced apart from each other by one or more cavities. Additionally, an anti-rotation element may extend into the one or more cavities of the piston to prevent rotation of the piston during rotation of the leadscrew. In turn, rotation of the leadscrew is translated completely into lateral movement of the piston.

According to another aspect of the invention, a distal end of the leadscrew is disposed within a support at an opposite end of the housing. The leadscrew is configured to freely rotate within the support.

According to yet another aspect of the invention, the drivetrain subassembly also includes a sensor to sense the rotation of the leadscrew. In turn, a control unit is configured to receive data from the sensor to determine the rotation of the leadscrew and, as a result, the associate location of the piston. The control unit is further configured to operate the first motor to rotate the leadscrew and laterally move the piston and separately operate the second motor to open and close the brine valve.

Yet another aspect of invention includes a water treatment system having a resin tank, a brine tank, and a multi-valve port as described above fluidically coupled to both the resin tank and the brine tank.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an isometric view of a water treatment system including a brine tank, a resin tank, and a multi-port valve;

FIG. 2 is a front isometric view of the multi-port valve of the water treatment system of FIG. 1;

FIGS. 3 and 4 are rear isometric views of the multi-port valve of FIG. 2;

FIG. 5 is a semi-exploded isometric view of the multi-port valve of FIG. 2;

FIG. 6 is an exploded isometric view of the drivetrain subassembly of the multi-port valve of FIG. 2;

FIG. 7 is an exploded isometric view of the injector subassembly of the multi-port valve of FIG. 2;

FIG. 8 is a cross-sectional view of a piston of the multi-port valve of FIG. 2;

FIG. 9 is an end view of the piston of the multi-port valve of FIG. 2;

FIG. 10 is a cross-sectional view of the multi-port valve of FIG. 2 with the piston oriented in a first position;

FIG. 11 is a cross-sectional view of the multi-port valve of FIG. 2 with the piston oriented in a second position;

FIG. 12 is a cross-sectional view of the multi-port valve of FIG. 2 with the piston oriented in a third position;

FIG. 13 is a cross-sectional view of the multi-port valve of FIG. 2 with the piston oriented in a fourth position;

FIG. 14 is a cross-sectional view of the multi-port valve of FIG. 2 with the piston oriented in a fifth position;

FIG. 15 is a cross-sectional view of the multi-port valve of FIG. 2 with the piston oriented in a sixth position; and

FIG. 16 is a front isometric view of a multi-port valve, according to another embodiment of the invention.

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

Throughout this description, various terms denoting direction, such as left and right, front and rear, up and down, top and bottom, and the like may be used. The directions are not intended to be limiting but are used to describe relationships of elements with respect to each other in the accompanying drawings. Unless mutually exclusive, it is contemplated that the elements may be reversed, for example, by turning a component around or upside down without deviating from the scope of the present invention.

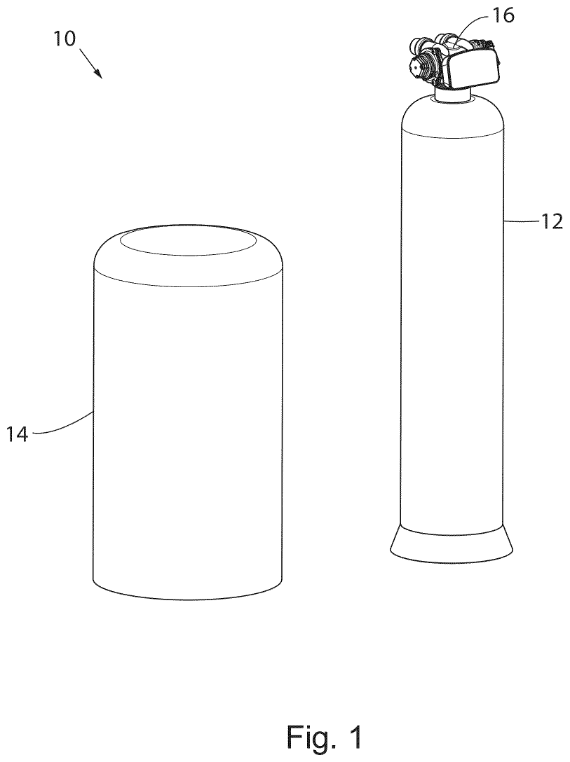

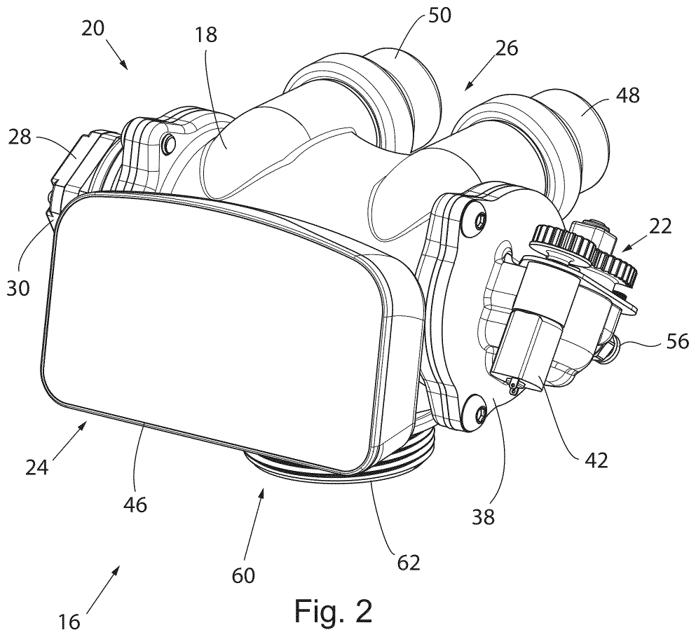

Turning initially to FIG. 1, a water treatment system 10 is shown according to a preferred embodiment of the invention. The water treatment system 10 is able to be used in many different applications (e.g., residential, commercial, etc.). The water treatment system 10 includes a resin tank 12 and a brine tank 14. A multi-port valve 16 is fluidically coupled to both the resin tank 12 and the brine tank 14. In the representative embodiment of the invention, the multi-port valve 16 is attached to an upper end of the resin tank 12. Additional aspects of the multi-port valve 16 will be described in further detail below in regard to FIGS. 2-15. In other embodiments of the invention, the water treatment system 10 may not include a brine tank and/or may include brine sources other than a brine tank 14.

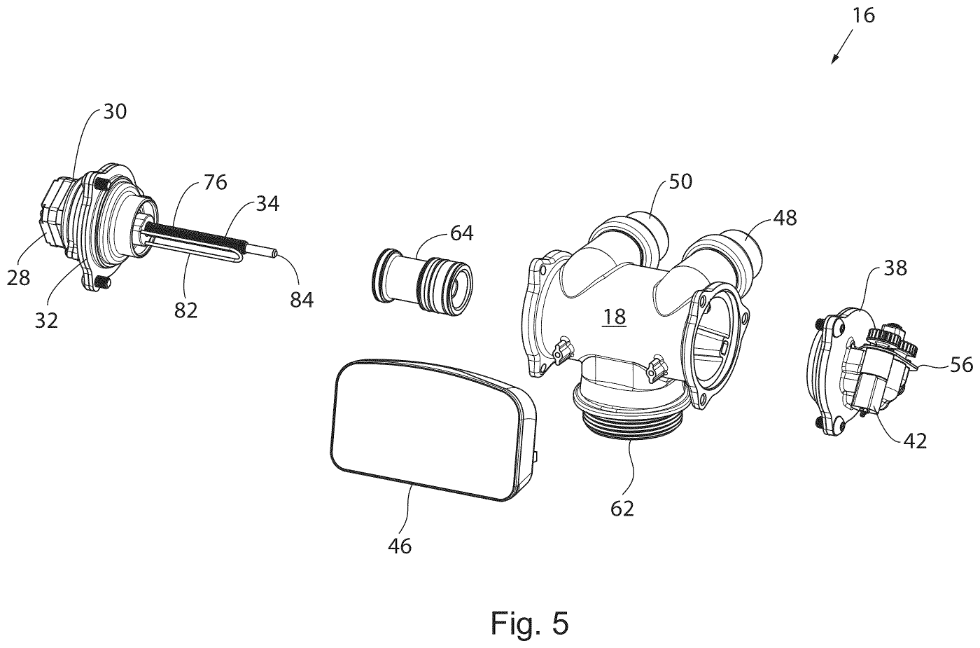

Referring now to FIGS. 2-5, the multi-port valve 16 is shown in greater detail. The multi-port valve 16 includes a housing 18 having a first, left end 20, a second, right end 22, a front end 24, and a rear end 26. A drivetrain subassembly 28 is mounted to the left end 20 of the housing 18. As shown in further detail in the exploded isometric view of FIG. 6, the drivetrain assembly 28 includes a stepper motor 30, a leadscrew 34, and a gearbox 32 to translate motion of the stepper motor 30 to rotation of the leadscrew 34. A sensor 36 is disposed within the gearbox 32 to sense rotation. For example, the sensor 36 may be a hall effect sensor and an associated magnetic disposed on or adjacent to the output shaft of the stepper motor 30 to measure rotation of the output shaft of the stepper motor and/or an associated pinion gear 37 coupled to the output shaft of the stepper motor 30 and, as a result, rotation of the leadscrew 34. Preferably, the sensor 36 may be in the form of an infrared sensor disposed on or adjacent to (for example, supported by a collar 39 of the subassembly) the output shaft of the stepper motor 30 to monitor the rotation, speed, and/or position of the output shaft of the stepper motor 30 and/or the associated pinion gear 37. As shown in FIG. 6, the gearbox 32 further includes a gear assembly 33 and bearings 35 to translate motion from stepper motor 30 to leadscrew 34.

The drivetrain subassembly 28 also includes an anti-rotation element 82 extending laterally in the same direction as leadscrew 34. In the representative embodiment of the invention, the anti-rotation element 82 extends parallel to the leadscrew 34. The anti-rotation element 82 will be described below in further detail below.

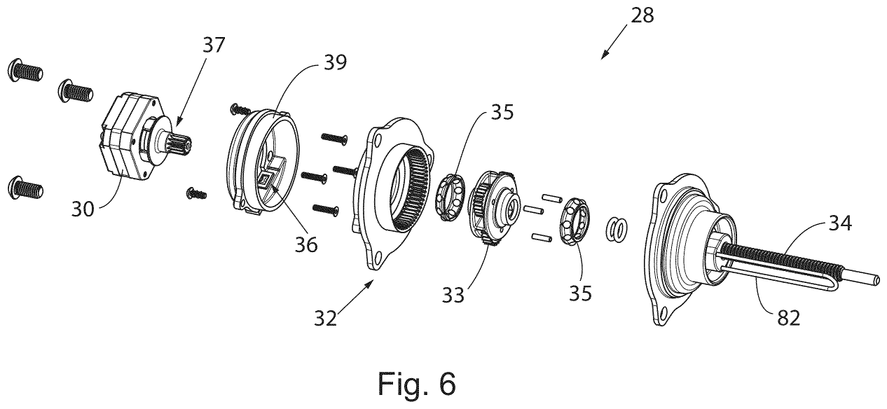

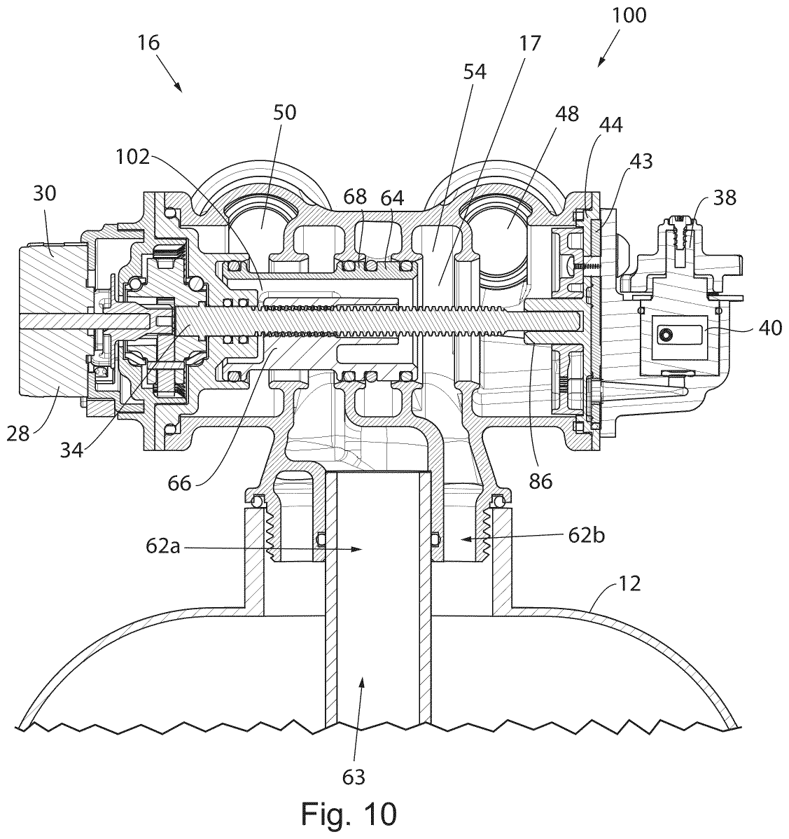

An injector subassembly 38 is mounted to the right end 22 of the housing 18. As shown in further detail in the exploded isometric view of FIG. 7, the injector assembly 38 includes a brine valve 40, a brine valve motor 42, a distributor plate 43, which may be in the form of a gasket 43, and a venturi plate 44. The motor 42 is configured to cause rotation of the brine valve 40, which may be in the form of a ceramic disk valve, in order to allow or prevent flow of brine into the multi-port valve 16. In the representative embodiment of the invention, the motor 42 causes rotation of the brine valve 40 via a series of gears. However, other embodiments of the invention may use other systems to translation motion of the motor 42 to the brine valve 40. Gasket 43 and venturi plate 44 are joined together with gasket 43 preferably made of rubber and providing a sealing face for venturi plate 44 which controls the flow rate of the brine as it is injected/flows into the multi-port valve 16. The venturi plate 44 also includes a venturi inlet 47 and a venturi outlet 49, both of which are in fluid communication with a cavity 54 of the multi-port valve 16. The alignment of these elements will be described in greater detail below in discussion of the cross-sectional views of the multi-port valve 16 in FIGS. 10-15.

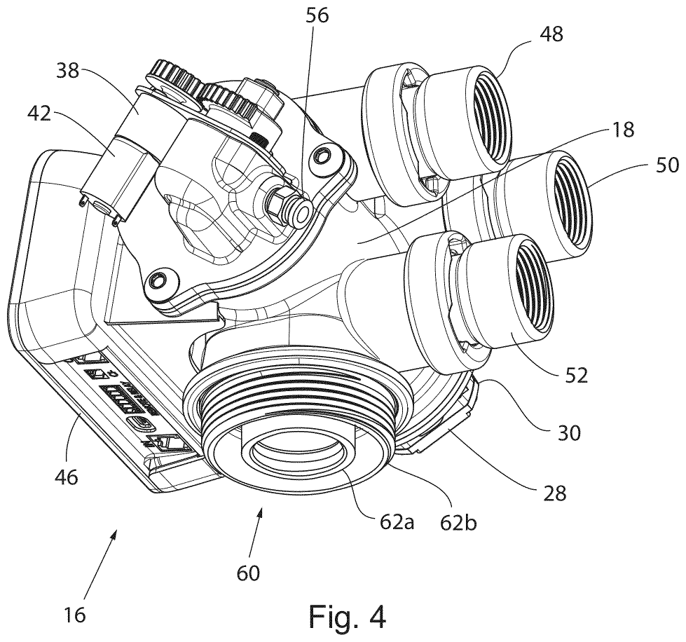

A control unit/user display 46 may be mounted to the front end 24 of the housing 18. The control unit/user display 46 is situated to be easily accessible by a user. Further, the control unit/user display 46 is configured to allow a user to control the water treatment system 10 and view information regarding the water treatment system 10. Control unit 46 is able to receive data from the sensor 36 regarding rotation of the leadscrew 34 that drives piston 64 (FIG. 5 and others), while also receiving data regarding, for example, the commanded number of pulses to the stepper motor 30. As a result, the control unit 46 is able to compare the sensed rotation of the leadscrew 34 and the number of pulses of the stepper motor 30 to accurately determine the rotation of the leadscrew 34 as it operates stepper motor 30. The control unit 46 is configured to operate the stepper motor 30 to rotate the leadscrew 34 any number of degrees by pulsing stepper motor 30 to translate piston 64, and then stop. The above comparison of sensed rotation of the leadscrew 34 with the number of pulses of the stepper motor 30 provides a closed feedback loop to confirm proper commanded operation of stepper motor 30. In sum, using stepper motor 30 provides precise piston translation by controlling shaft orientation with steps that are at, for example, 1.8 degree intervals.

The control unit 46 is further configured to predict when the multi-port valve 16 should undergo service or maintenance. For example, sensor 36 is able to monitor the speed at which stepper motor 30 pulses. In addition, a comparison between the data regarding the number of pulses of the stepper motor 30 and the data from the sensor 36 regarding rotation of the leadscrew 34 allows for the control unit 46 to determine if there are missed steps of the stepper motor 30. That is, if the stepper motor 30 pulses, but the sensor 36 determines that there was no rotation of the leadscrew 34, the control unit 46 is able to compare the two and determine that the stepper motor 30 did not actually step in response to the pulse and, therefore, maintenance may be required. In turn, the control unit 46 is able to predict when components within the drivetrain assembly 28 (such as, but not limited to, internal seals, gear assembly 33, bearings 35, etc.) need to be serviced or replaced in advance of failure, again by monitoring changes in speed or “missed steps.”

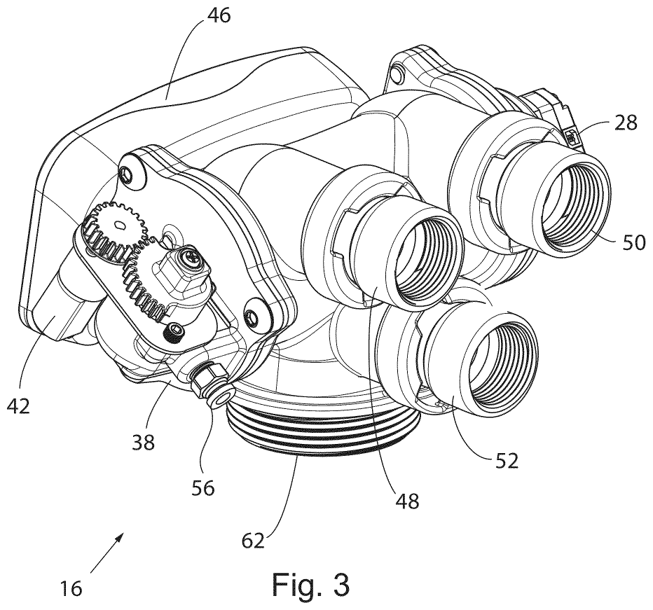

The rear isometric views of the housing 18 of FIGS. 3 and 4 depict a plurality of openings/ports in the rear end 26 of housing 18. These ports include an inlet port 48, and outlet port 50, and a drain port 52 and are each fluidically coupled to an interior cavity 54 of the multi-port valve 16. The inlet port 48 is configured to fluidically couple the cavity 54 of the multi-port valve 16 to an ingoing water line to receive untreated water from a system, the outlet port 50 is configured to fluidically couple the cavity 54 of the multi-port valve 16 to an outgoing water line to provide water to a system, and the drain port 52 is configured to fluidically couple the cavity 54 to a drain to assist in discharging water from the system. Additionally, the injector subassembly 38 includes a brine port 56. In turn, a hose 58 (see FIG. 1) may be coupled to the brine port 56 to fluidically couple the injector subassembly 38 and the multi-port valve 16 to the brine tank 14 of the water treatment system 10. A bottom 60 of the housing 18 also includes a resin port 62 that fluidically couples the cavity 54 of the multi-port valve 16 with the resin tank 12. The resin port 62 includes a first, inner resin port 62a and a second, outer resin port 62b, which are configured to interact with a bottom portion of the resin tank 12 (via a distributor 63 extending through the resin of the resin tank 12) and a top portion of the resin tank 12, respectively.

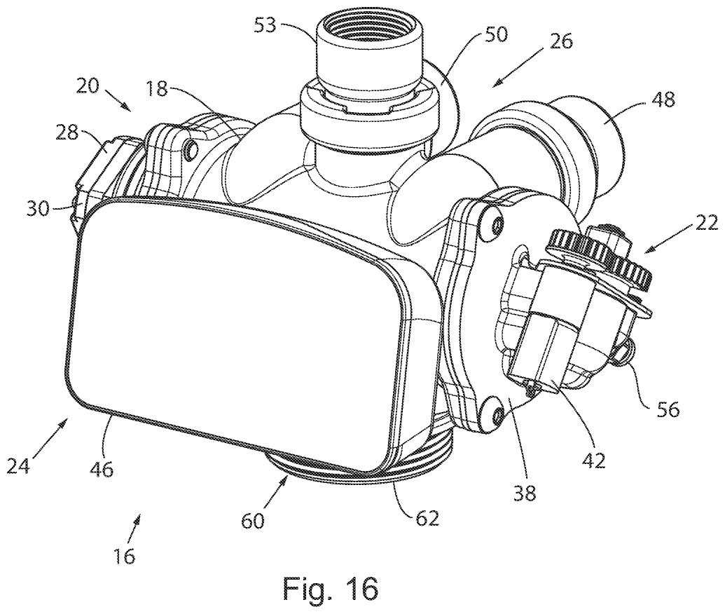

While FIGS. 3 and 4 illustrate the drain port 52 as being oriented parallel to the inlet port 48 and outlet port 50 at the rear end 26 the housing 18, the drain port 52 may be oriented at other angles and at other locations on the housing 18. For instance, as shown in FIG. 16, the drain port may be in the form of drain port 53, which extends upward from a top end of the housing 18. In such an orientation, the valve 16 is less likely to leak via drain port 53 onto the floor when removing the drain adapter, for example, during maintenance of the valve 16. In yet other embodiments of the invention, the drain port 52, the inlet port 48, and the outlet port 50 can be oriented at angle and/or at any location of the housing 18.

As shown in FIG. 5, the multi-port valve 16 also includes a piston 64 driven by leadscrew 34 controlled by stepper motor 30. Piston 64 is disposed within cavity 54 of multi-port valve 16, and configured to traverse laterally within the cavity 54 in order to align different ports with each other for different operations of the water treatment system 10. Specific alignments of the piston 64 will be discussed in further detail when describing FIGS. 10-15 below.

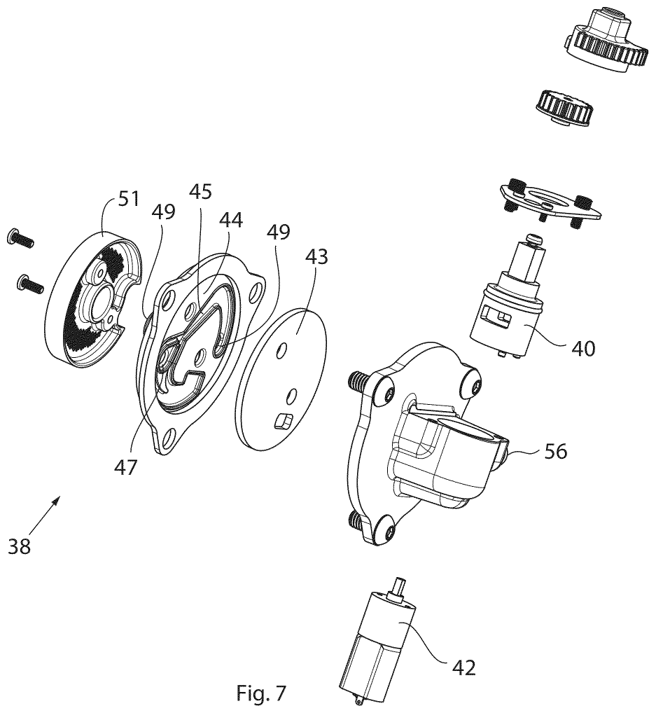

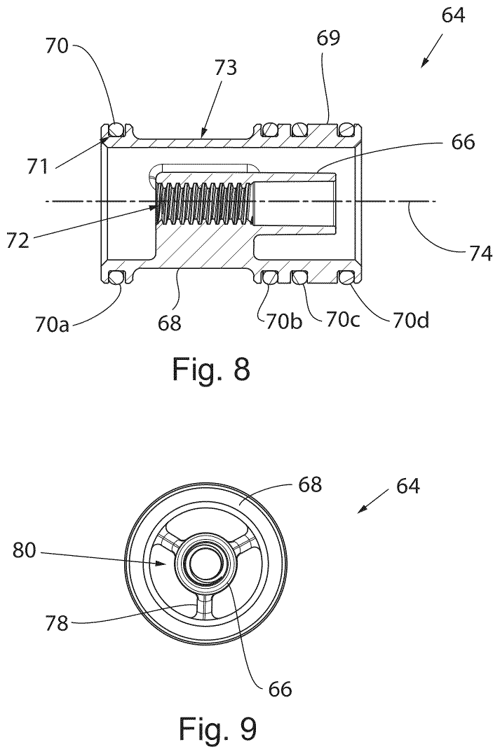

FIGS. 8 and 9 illustrate a cross-sectional view and an end view, respectively, of the piston 64 of the multi-port valve 16. The piston 64 includes an inner portion 66 and an outer portion 68. The outer portion 68 of the piston 64 is configured to receive a number of gaskets 70 on an outer surface 69 thereof within recesses 71 formed in the outer surface 69 thereof. The outer surface 69 of the outer portion 68 of the piston 64 further includes an operational recess 73 formed therein, the function of which will later be described in further detail. While FIG. 8 illustrates the use of four gaskets 70a-70d, varying embodiments of the invention may use any number of gaskets or other sealing arrangements. As described in further detail below, the gaskets 70 act to seal fluid pathways within the cavity 54 of the multi-port valve 16 as the piston 64 translates along the cavity 54. The inner portion 66 of the piston 64 is configured to include a threaded portion 72 aligned with a central axis 74 of the piston 64. The threaded portion 72 of the piston 64 is configured to interfit with a threaded portion 76 of the leadscrew 34. As a result, rotation of the leadscrew 34 causes lateral movement of the piston 64 within the cavity 54 of the multi-port valve 16. In a preferred embodiment of the invention, the leadscrew 34 is able to rotate while maintaining a stationary lateral position and cause lateral movement of the piston 64.

As shown in FIGS. 10-15, and unlike conventional multi-port valves, the threaded portion 76 of the leadscrew 34 and the piston 64 are disposed within the cavity 54 of the multi-port valve 16. More specifically, the threaded portion 76 of the leadscrew 34 and the piston 64 are disposed within a pressure vessel region 17 of the multi-port valve 16. The pressure vessel region 17 is associated with the area of the cavity 54 located between each of the ports 48, 50, 52, 62. By having the leadscrew 34 rotate to cause lateral movement of the piston 64 via the connection of the threaded portions 72, 76, the system ensures that pressure within the pressure vessel region 17 acting on the piston 64 does not cause movement of the leadscrew 34. As a result the control unit 46 is able to accurately determine the location of the piston 64 based on the sensed rotation of the leadscrew 34.

FIG. 9 illustrates one or more supports 78 extending between the inner portion 66 and the outer portion 68 of piston 64 and are configured to attach the inner and outer portions 66, 68 together while creating one or more cavities 80 disposed between the supports 78. In the representative embodiment of the invention, the piston 64 includes three supports 78 and three cavities 80. In other embodiments of the invention, the piston 64 may include any number of supports 78 of varying thicknesses and any number of cavities 80 of varying sizes. The anti-rotation extension 82 of the drivetrain assembly 28 is configured to extend into one of the cavities 80 of the piston 64. In turn, the extension 82 prevents rotation of the piston 64 in response to rotation of the leadscrew 34, which results in the rotation of the leadscrew 34 translating efficiently to lateral movement of the piston 64 without loss to rotation of the piston 64. In varying embodiments of the invention, there may be any number of anti-rotation extensions 82 extending through any number of cavities 80 of the piston 64 to prevent rotation of and rotationally stabilize the piston 64.

FIGS. 10-15 depict cross-sectional views of the multi-port valve 16 with the piston 64 in a number of orientations. Each orientation of FIGS. 10-15 provides a different operation of the multi-port valve 16. As shown in the cross-sectional views, the leadscrew 34 extends into the cavity 54 of the multi-port valve 16. The threaded portion 76 of the leadscrew 34 extends through the cavity 54 of the multi-port valve 16 and is aligned with the central axis 74 of the piston 64. As the leadscrew 34 rotates, it causes the piston 64 to laterally travel along the threaded portion 76 of the leadscrew 34. In the representative embodiment of the invention, the lead screw 34 extends to the injector subassembly 38. While it is contemplated that the lead screw 34 may be cantilevered within the cavity 54 of the multi-port valve 16, a preferred embodiment of the invention has a distal end 84 of the leadscrew 34 received by a support 86 formed in or attached to the injector assembly 38. As a result, the leadscrew 34 is stabilized within the system. The distal end 84 of the leadscrew 34 is configured to freely rotate within the support 86. In a further preferred embodiment, the support 86 extends outward from the venturi plate 44 and receives the distal end 84 of the leadscrew 34.

FIG. 10 illustrates the multi-port valve 16 in a first position 100, such as a service position. The service position 100 is a primary position of the multi-port valve 16 and is maintained in this position for a majority of the operation of the multi-port valve 16 and the water treatment system 10. In the service position 100, the piston 64 is located at a far left position 102. In turn, the piston 64 opens a pathway from the inlet port 48 to the outer resin port 62b and blocks a pathway to from the inlet port 48 to the outlet port 50, the drain port 52, and the inner resin port 62a. (the previously discussed gaskets 70 interact with one or more inner surfaces of the multi-port valve 16 extending into the cavity 54 to provide a fluid tight seal and block pathways). Meanwhile, the operational recess 73 of the piston 64 is positioned to open a pathway between the inner resin port 62a and the outlet port 50. Further, the brine motor 42 operates to close the brine valve 40.

As a result, the fluid enters the multi-port valve 16 via the inlet port 48, flows to the top of the resin tank 12 via the outer resin port 62b, flows through the resin tank 12 to the bottom portion thereof (the fluid is treated in the resin within the resin tank 12 as it flows from the top portion to the bottom portion of the resin tank 12), flows through from the bottom portion thereof the distributor 63 of the resin tank to the inner resin port 62a, and then flows to the outlet port 50.

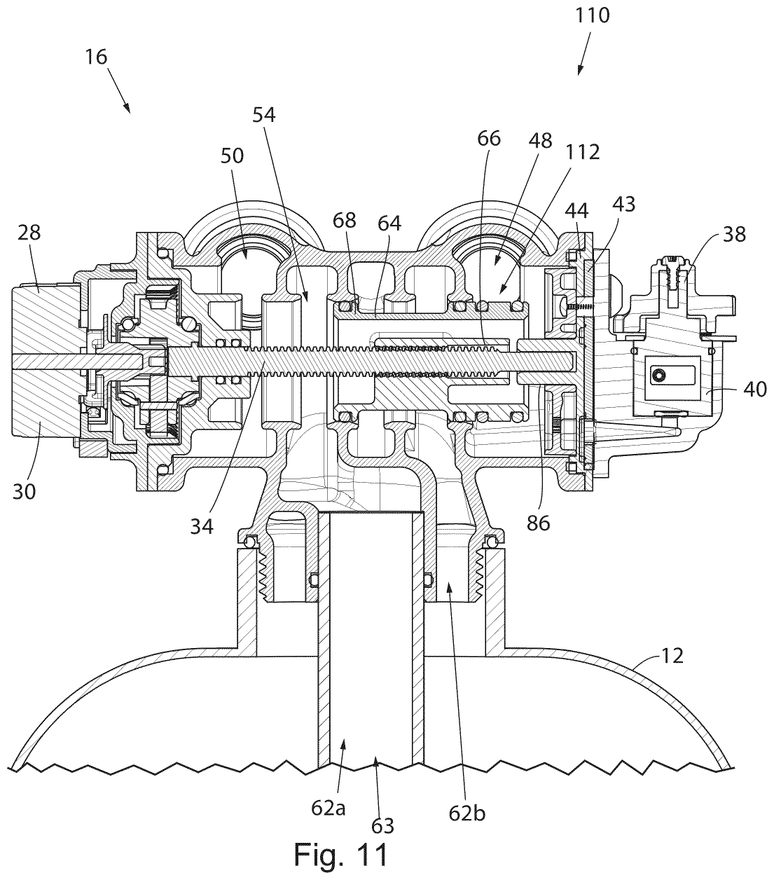

FIG. 11 illustrates the multi-port valve 16 in a second position 110, such as a backwash position. In the backwash position 110, the piston 64 is located at a far right position 112. As a result, the piston 64 blocks the pathway from the inlet port 48 to the outer resin port 62b, while opening a pathway from the inlet port 48 to the inner resin port 62a and from the inlet port 48 to the outlet port 50 (the previously discussed gaskets 70 interact with one or more inner surfaces of the multi-port valve 16 extending into the cavity 54 to provide a fluid tight seal to block and open pathways). Meanwhile, the operational recess 73 of the piston 64 is aligned to create a pathway between the outer resin port 63a and the drain port 52. Further, the brine motor 42 operates to close the brine valve 40.

As a result, fluid is able to flow directly from the inlet port 48 to the outlet port 50, while also being able to flow from the inlet port 48 to the bottom portion of the resin tank 12 via the distributor 63. The fluid is able to then flow from the bottom portion of the resin tank 12 to the top portion of the resin tank 12, into the cavity 54 of the multi-port valve 16, and out the drain port 52. This results in a backwash flow that assists in cleaning the resin tank 12.

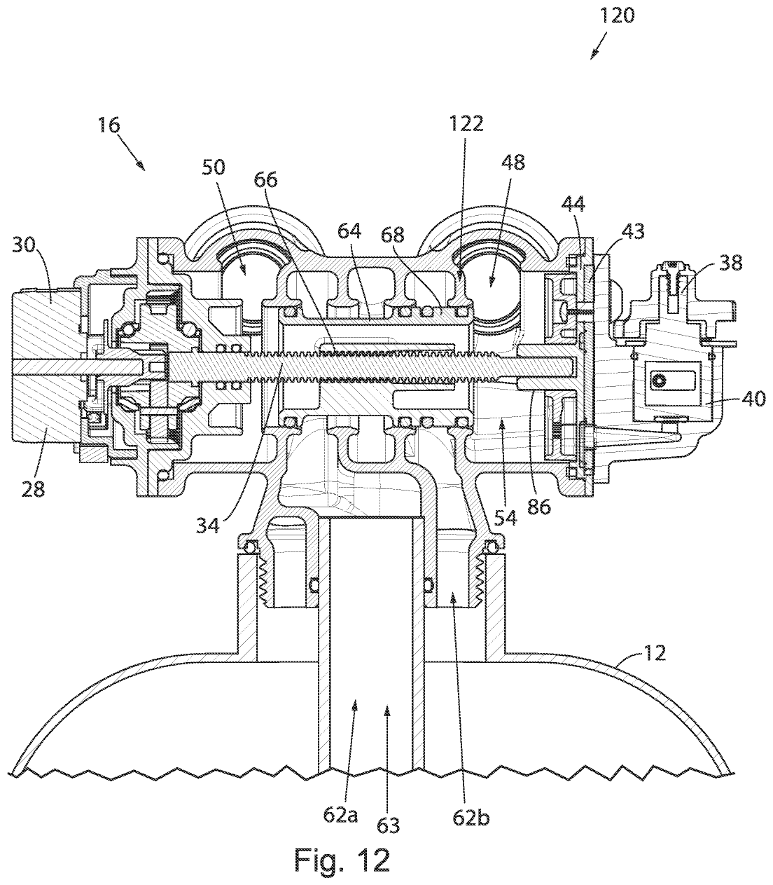

FIG. 12 illustrates the multi-port valve 16 in a third position 120, such as a brine draw position. The brine draw position 120 is used to rinse the resin within the resin tank 12 with brine in order to regenerate the resin. In the brine draw position 120, the piston 64 is located at a middle position 122 and the brine motor 42 operates to open the brine valve 40. As a result, the piston 64 opens a pathway from the inlet port 48 to the venturi inlet 47 and from the inlet port 48 to the outlet port 50, while also blocking a direct pathway from the inlet port 48 to the inner resin port 62a, outer resin port 62b, and drain port 52 (See FIGS. 4 and 10). In addition, the piston 64 in the middle position 122 opens a pathway within the cavity 54 of the multi-port valve 16 from the venturi outlet 49 (FIG. 7) to the outer resin port 62b. Additionally, the operational recess 73 of the piston 64 is aligned to open a pathway from the inner resin port 62a to the drain port 52.

As a result, fluid is able to flow from the inlet port 48 to the outlet port 50, while also being able to flow into the venturi 45 via the venturi inlet 47. As shown in FIG. 7, the injector subassembly 28 may also include a screen filter 51 to screen fluid before it reaches the venturi inlet 47. The brine is able to be injected into the fluid by way of the venturi 45 and the resultant combination fluid then flows into the top portion of the resin tank 12 via the outer resin port 62b. After passing through the resin within the resin tank 12, the combination fluid then travels through the inner resin port 62a and into the cavity 54 (via the distributor 63) on its way to the drain port 52.

In an alternative brine draw position, the piston 64 may be located at an alternative middle position with the brine motor 42 operating to open the brine valve 40. As a result, the piston 64 opens a pathway from the inlet port 48 to the venturi inlet 47 and from the inlet port 48 to the outlet port 50, while also blocking a direct pathway from the inlet port 48 to the inner resin port 62a, outer resin port 62b, and drain port 52. In addition, the piston 64 in the alternative middle position opens a pathway within the cavity 54 of the multi-port valve 16 from the venturi outlet 49 (FIG. 7) to the inner resin port 62b. Additionally, the operational recess 73 of the piston 64 is aligned to open a pathway from the outer resin port 62a to the drain port 52.

As a result, fluid is able to flow from the inlet port 48 to the outlet port 50, while also being able to flow into the venturi 45 via the venturi inlet 47. The brine is able to be injected into the fluid by way of the venturi 45 and the resultant combination fluid then flows into the bottom portion of the resin tank 12 via the inner resin port 62a and the distributor 63. After passing through the resin within the resin tank 12, the combination fluid then travels through the outer resin port 62b and into the cavity 54 on its way to the drain port 52.

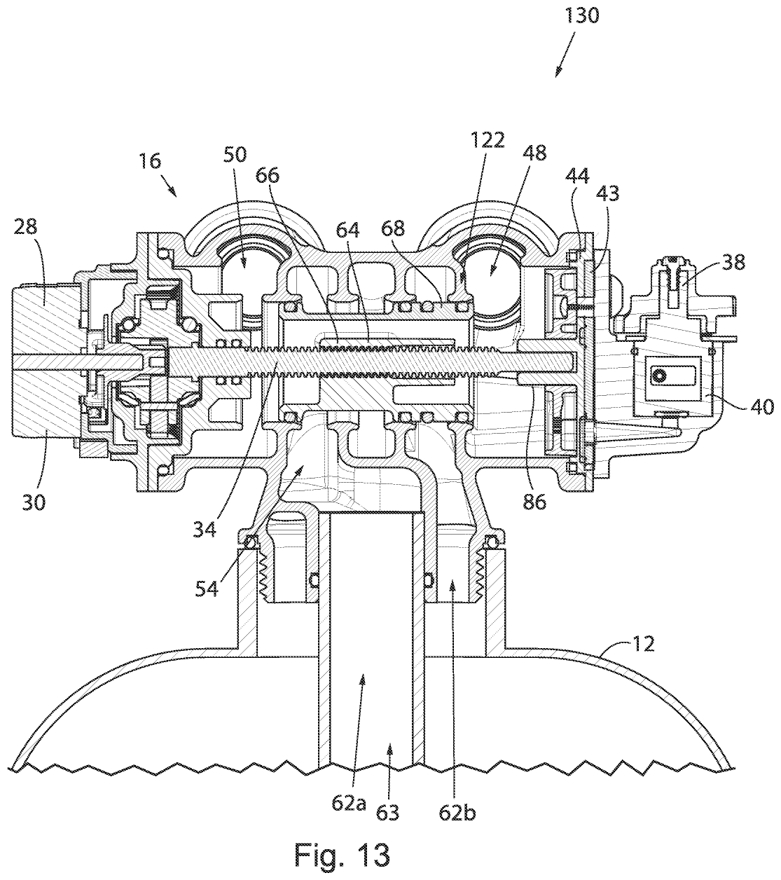

FIG. 13 illustrates the multi-port valve 16 in a fourth position 130, such as a slow rinse position. In the slow rinse position 130, the piston 64 is located in the same middle position 122 as FIG. 12 and the brine draw position 120, but the brine motor 42 operates to close the brine valve 40. As a result, the piston 64 opens a pathway from the inlet port 48 to the venturi inlet 47 and from the inlet port 48 to the outlet port 50, while also blocking a direct pathway from the inlet port 48 to the inner resin port 62a, outer resin port 62b, and drain port 52. In addition, the piston 64 in the middle position 122 opens a pathway within the cavity 54 of the multi-port valve 16 from the venturi outlet 49 to the outer resin port 62b. Additionally, the operational recess 73 of the piston 64 is aligned to open a pathway from the inner resin port 62a to the drain port 52, while blocking a direct pathway from the inner resin port 62a to the outlet port 50.

As a result, fluid is able to flow from the inlet port 48 to the outlet port 50, while also being able to flow into the venturi 45 via the venturi inlet 47. Because the brine valve 40 is closed, the fluid flows through the venturi 45 without injection of brine. This results in a slow, controlled flow speed of the fluid as it flows from the venturi outlet 49 to the outer resin port 62b, into the top portion of the resin tank 12, and through the resin. After passing through the resin within the resin tank 12, the fluid then travels through the inner resin port 62a and into the cavity 54 (via the distributor 63) on its way to the drain port 52.

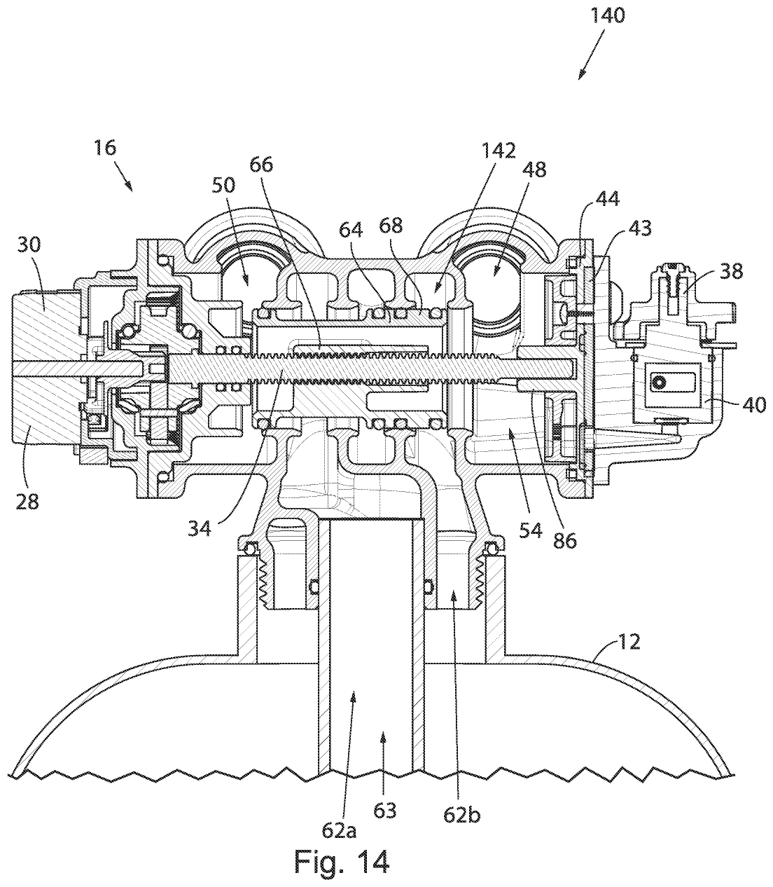

FIG. 14 illustrates the multi-port valve 16 in a fifth position 140, such as a fast rinse position. In the fast rinse position 140, the piston 64 moves laterally left from the middle position 122 to an offset middle position 142. Additionally, the brine valve 40 is closed. In the offset middle position 142, the piston 64 opens a pathway from the inlet port 48 to the outer resin port 62b and from the inlet port 48 to the outlet port 50, while also blocking a direct pathway from the inlet port 48 to the inner resin port 62a, outer resin port 62b, and drain port 52. In addition, the operational recess 73 of the piston 64 is aligned to open a pathway from the inner resin port 62a to the drain port 52, while blocking a direct pathway from the inner resin port 62a to the outlet port 50.

As a result, the fluid is able to flow from the inlet port 48 to the outlet port 50, while also being able to flow from the inlet port 48 to the outer resin port 62b. This results in a faster flow speed of the fluid to the outer resin port 62b, into the top portion of the resin tank 12, and through the resin, when compared to the slow rinse position 130 described above (see FIG. 13). After passing through the resin within the resin tank 12, the fluid then travels through the inner resin port 62a and into the cavity 54 (via the distributor 63) on its way to the drain port 52.

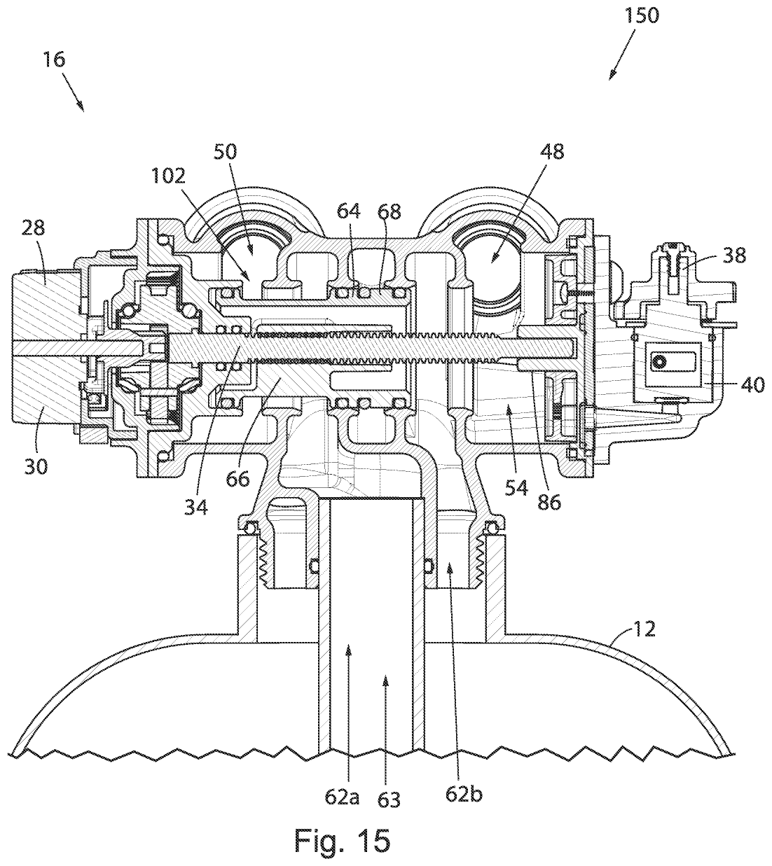

FIG. 15 illustrates the multi-port valve 16 in a sixth position 150, such as a brine fill position. In the brine fill position 150, the piston 64 moves to the far left position 102 shown in FIG. 12, but the brine valve 40 is open. In turn, the piston 64 opens a pathway from the inlet port 48 to the outer resin port 62b and blocks a pathway to the drain port 52. Meanwhile, the operational recess 73 of the piston 64 is positioned to open a pathway between the inner resin port 62a and the outlet port 50.

As a result, the fluid enters the multi-port valve 16 via the inlet port 48, flows to the top of the resin tank 12 via the outer resin port 62b, flows through the resin tank 12 to the bottom portion thereof (the fluid is treated in the resin within the resin tank 12 as it flows from the top portion to the bottom portion of the resin tank 12), flows from the bottom portion of the resin tank 12 (via the distributor 63) to the inner resin port 62a, and then flows to the outlet port 50. With the brine valve 40 in the open position, fluid is also able to flow from the inlet port 48 and into the brine tank 14, via the brine valve 40.

In an alternative brine fill position, the piston 64 may be located at an alternative left position with the brine motor 42 operating to open the brine valve 40. In turn, the piston 64 opens a pathway from the inlet port 48 to the outer resin port 62b and blocks a pathway to the drain port 52. Meanwhile, the operational recess 73 of the piston 64 is positioned to open a pathway between the inner resin port 62a and the outlet port 50. In addition, a pathway is opened from the inner resin port 62b and the brine port 56.

As a result, the fluid enters the multi-port valve 16 via the inlet port 48, flows to the top of the resin tank 12 via the outer resin port 62b, flows through the resin tank 12 to the bottom portion thereof (the fluid is treated in the resin within the resin tank 12 as it flows from the top portion to the bottom portion of the resin tank 12), flows from the bottom portion of the resin tank 12 (via the distributor 63) to the inner resin port 62a, and then flows to the outlet port 50. With the brine valve 40 in the open position, fluid is also able to flow from the inlet port 48, to the outer resin port 62b, through the resin tank 12, to the inner resin port 62a (via the distributor 63), and into the brine tank 14, via the brine valve 40. In this alternative brine refill position, the brine tank 14 is refilled with treated water.

As discussed previously, the stepper motor 30 operates to rotate the leadscrew 34, and rotation of the leadscrew 34 causes lateral movement of the piston 64 between the positions described above and shown in FIGS. 10-15. In addition to operating the stepper motor 30, the control unit 46 is able to determine the position of the piston 64 based on the rotation of the leadscrew 34 as sensed by the sensor 36 (FIG. 6). Separately, the brine motor 42 operates to open and close the brine valve 40. That is, operation of the leadscrew 34 and piston 64 are independent from operation of the brine valve 40. In turn, the water treatment system 10 is able to cycle through the positions described above in any order at any frequency. Additionally, a brine level sensor (not shown) may be located in the brine tank 14 to determine when a brine refill is needed.

Independent operation of the brine valve 40 further allows for control of the flow of brine through the brine valve 40. That is, a size of the orifice of the brine valve 40 may be adjusted to increase or decrease the brine flow through the brine valve 40 and to the venturi 55. This could be utilized in both the brine draw position and the brine fill position.

In addition, translation of rotational motion of the leadscrew 34 to lateral motion of the piston 64 allows for leadscrew 34 to remain laterally stationary within multi-port valve 16. In turn, multi-port valve 16 and its drivetrain subassembly 28 do not need to be sized to compensate for lateral movement of the leadscrew 34 and, therefore, dimensions can be optimized to accommodate all types of installations. Further yet, disposing the threaded portion 76 of the leadscrew 34 and the piston 64 within the pressure vessel region 17 of the multi-port valve 16 allows for the multi-port valve 16 and its drive train assembly 28 to have its dimensions optimized to accommodate all types of installations.

The design of the preferred embodiment also enables an automatic piston removal/installation feature. It is the translation of rotational motion of the leadscrew 34 to lateral motion of the piston 64 that allows ready removal and installation of piston 64. For instance, the injector subassembly 38 may be removed from the right end 22 of the housing 18 to expose the cavity 54 of the multi-port valve 16. In turn, the control unit 46 may operate the stepper motor 30 to rotate the leadscrew 34 to laterally move the piston 64 until it is ejected and for removal by a user from the right side 22 of the housing. Similarly, the user may install piston 64 by placing it at the distal end 84 of the leadscrew 34 and operating the control unit 46 to operate the stepper motor 30 to rotate the leadscrew 34 oppositely to laterally move the piston 64 back into the pressure vessel region 17 of the multi-port valve 16. The injector subassembly 38 may then be mounted to the right end 22 of housing 18.

In an alternative embodiment of the removal/installation feature, movement/translation of leadscrew 34 in any direction, whether rotational movement and/or lateral movement in a direction transverse, orthogonal, or at an angle comparative to the direction of piston 64, that causes movement of piston 64 may be used to allow ready removal and installation of piston 64 at an end of the housing 18, such as, but not limited to, the right end 22 of housing 18.

Although the best mode contemplated by the inventors of carrying out the present invention is disclosed above, practice of the present invention is not limited thereto. It will be manifest that the various additions, modifications, and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

We claim:

1. A multi-port valve for a water treatment system, the multi-port valve comprising:
a housing having an inlet port, an outlet port, a drain port, a first resin port, a second resin port, and a cavity fluidically coupling each of the ports;
a drivetrain subassembly coupled to the housing, the drivetrain subassembly including a first motor and a leadscrew;
an injector subassembly coupled to the housing, the injector subassembly including a second motor, a brine port, and a brine valve; and
a piston disposed on the leadscrew and configured to laterally traverse a length of the leadscrew in response to rotation of the leadscrew.

2. The multi-port valve of claim 1, wherein the piston includes an inner portion and an outer portion, the inner portion having a central axis aligned with a central axis of the leadscrew.

3. The multi-port valve of claim 2, wherein the inner portion of the piston includes a threaded portion configured to receive a threaded portion of the leadscrew.

4. The multi-port valve of claim 2, wherein the piston further includes at least one support extending between the inner and outer portions of the pistons and one or more cavities disposed between the supports.

5. The multi-port valve of claim 4, further comprising an anti-rotation element extending into the one or more cavities of the piston to prevent rotation of the piston during rotation of the leadscrew.

6. The multi-port valve of claim 1, wherein a distal end of the leadscrew is disposed within a support at an opposite end of the housing, the leadscrew configured to freely rotate within the support.

7. The multi-port valve of claim 6, wherein the support prevents lateral movement of the leadscrew.

8. The multi-port valve of claim 6, wherein the support extends from a surface of the injector subassembly.

9. The multi-port valve of claim 1, wherein the drivetrain subassembly further includes a sensor to sense the rotation of the leadscrew.

10. The multi-port valve of claim 9, further comprising a control unit configured to:
operate the first motor to rotate the leadscrew and laterally move the piston;
operate the second motor to open and close the brine valve; and
receive data from the sensor to determine the rotation of the leadscrew and associated location of the piston.

11. The multi-port valve of claim 1, wherein the piston and the leadscrew are disposed within the cavity of the housing.

12. A water treatment system comprising:
a resin tank;
a multi-port valve in fluid communication with the resin tank, the multi-port valve comprising:
a housing having an inlet port fluidically coupled to a water inlet, an outlet port fluidically coupled to a water outlet, a drain port, a first resin port fluidically coupled to a bottom portion of the resin tank, a second resin port fluidically coupled to a top portion of the resin tank, and a cavity fluidically coupling each of the ports;
a drivetrain subassembly coupled to the housing, the drivetrain subassembly including a first motor and a leadscrew;
an injector subassembly coupled to the housing, the injector subassembly including a second motor, a brine port, a brine valve; and
a piston disposed on the leadscrew and configured to laterally traverse a length of the leadscrew in response to rotation of the leadscrew.

13. The water treatment system of claim 12, wherein the piston includes an inner portion and an outer portion, the inner portion having a central axis aligned with a central axis of the leadscrew.

14. The water treatment system of claim 13, wherein the inner portion of the piston includes a threaded portion configured to receive a threaded portion of the leadscrew.

15. The water treatment system of claim 13, wherein the outer portion of the piston includes a plurality of gaskets formed therein to fluidically seal select areas of the cavity at different locations of the piston within the cavity.

16. The water treatment system of claim 13, wherein the piston further includes at least one support extending between the inner and outer portions of the pistons and one or more cavities disposed between the supports.

17. The water treatment system of claim 15, further comprising an anti-rotation element extending into the one or more cavities of the piston to prevent rotation of the piston during rotation of the leadscrew.

18. The water treatment system of claim 12, wherein a distal end of the leadscrew is disposed within a support at an opposite end of the housing, the leadscrew configured to freely rotate within the support.

19. The water treatment system of claim 12, wherein the drivetrain subassembly further includes a sensor to sense the rotation of the leadscrew.

20. The water treatment system of claim 19, further comprising a control unit configured to:
operate the first motor to rotate the leadscrew and laterally move the piston;
operate the second motor to open and close the brine valve; and
receive data from the sensor to determine the rotation of the leadscrew and associated location of the piston.
